(19) United States
(12) Patent Application Publication
(10) Pub. No.: US 2026/0062972 A1
(43) Pub. Date: Mar. 5, 2026

(54) ADJUSTABLE DEVICE FOR THE MOVEMENT OF THE FLOOR OF SLIDING DOORS

(71) Applicant: TERNO SCORREVOLI S.P.A. UNIPERSONALE, Varedo (IT)

(72) Inventors: Giovanni TERNO, Varedo (IT); Emanuele MENI, Varedo (IT)

(21) Appl. No.: 19/108,307

(22) PCT Filed: Jul. 24, 2023
(86) PCT No.: PCT/EP2023/025346

§ 371 Date: Mar. 3, 2025

(30) Foreign Application Priority Data
Sep. 5, 2022 (IT) 102022000018099

(51) Int. Cl. E05D 15/06

(52) U.S. Cl. CPC E05D 15/0669; E05Y 2201/64; E05Y 2600/12; E05Y 2900/132

(57) ABSTRACT

An adjustable device (10) for the movement on the floor of single or double sliding door(s) (12) to be aligned with a wall (14) comprises a rubber wheel (16) connected through a pin (20) to a frame (18), combined with a pad (26) made of elastomeric material and provided with overlapping elastic sheets (22), fixed with screws (24) to a load-bearing frame. Said frame is formed by a fixing base (28) and by a tilting support (36) in which the means for adjustment and alignment of the door(s) (12) are arranged. The fixing base (28) defines a substantially rectangular plane and is provided, along the opposite major sides, with integral flanks (30) folded at 90° on each of which, at one end of the same fixing base (28), a through hole (32) is formed to accommodate a pin (34) for connecting and articulating to the tilting support (36).

### DESCRIPTION

The present invention relates to an adjustable device for the movement on the floor of sliding doors.

More in particular, the present invention relates to a device that not only allows single or double sliding doors to slide optimally on the floor but also compensates for any tilting from the vertical of the doors.

As it is known, sliding doors are diffusely used and appreciated for their functional features, since they do not protrude into the interior of the room once opened; in some embodiments, these doors fit concealed, once opened, into a special recess in the wall, making them completely invisible. In the upper portion, the sliding door generally includes a sliding track, coupled with at least one carriage fixed to the wall; the door is opened and closed by sliding the rail on the wheels of the fixed carriage. From the lower portion of the door, according to a well-known embodiment, protrudes in part a pair of spring-loaded wheels, connected to respective supports built into the ends of the lower edge of the door; the door translates as a result of the rolling on the floor of said spring-loaded wheels. One such solution disclosed in EP 2,646,635; EP 3,665,52, in the name of the same applicant, also refers to a similar solution, in which an opposing bottom rail is fixed to the floor and is defined by a projecting appendage such as a pin or the like that, protruding upward, engages and locks along a longitudinal milling cut in the lower end of the door. Also known from WO2019/029838 is a device for floor-mounted sliding doors, comprising a fork frame fited with one or more elastic sheets, while French PatentFR 2332406 discloses a sliding door frame carriage, consisting of two components connected by a screw; the wheels of the carriage are supported by respective shafts, which a repress-fitted into a support element.

This kind of system is very suitable for the construction of designer doors, since the mechanisms that enable their movement are completely hidden from view; however, it has been found that the known solutions have a major drawback. Indeed, although the weight of the door is distributed between the upper carriage fixed to the wall and the spring-loaded wheels placed at the bottom, it may happen that the door itself tilts to one side, namely in the direction of the side opposite to that where the above-mentioned carriage is located; this is because the relevant spring-loaded wheel flexes to a greater extent than the other, being more subject to the weight of the sliding door.

Another instance in which the door tilts occurs when it slides on an uneven floor that is not properly leveled, or when the floor has depressions or reliefs along the sliding track. The inclination of the door with respect to the vertical line is not acceptable from an aesthetic point of view, especially for solutions in which the door itself is made of glass and has an aluminum frame; this inclination, in fact, would emerge in relation to the edge of the compartment, which is visible beyond the glass of the frame. Yet another occurrence of possible inclination arises when the door is located to close a corridor and has to abut against the defining side wall of the corridor itself; in this situation, the door would abut only at the top, leaving a gap at the bottom.

The inclination of the door also limits the use of this solution to the single sliding door and is not applicable to the double sliding doors. In the case of double doors, in fact, the inclination of the two opposing sliding doors would result in them abutting at the top, while an unacceptable and unsightly larger or smaller gap would be created at the bottom.

The purpose of the present invention is to remedy the aforementioned drawbacks.

More in particular, the purpose of the present invention is to provide an adjustable device for the movement on the floor of sliding doors that can compensate for the possible tilt of single sliding doors or double sliding doors by aligning them vertically.

Further purpose of the invention is to provide an adjustable device that can compensate for any depression in the floor, improving the sliding of single sliding doors.

A further purpose of the invention is to make available to users an adjustable device for floor movement of sliding doors that can guarantee a high level of strength and reliability overtime, and such that it can be easily and inexpensively manufactured.

These and other purposes are achieved by the adjustable device of the present invention in accordance with the main claim.

The constructional and functional specifications of the adjustable device of the invention may be beter understood from the following disclosure, in which reference is made to the attached tables of drawings that represent a preferred and non-limiting embodiment and in which:

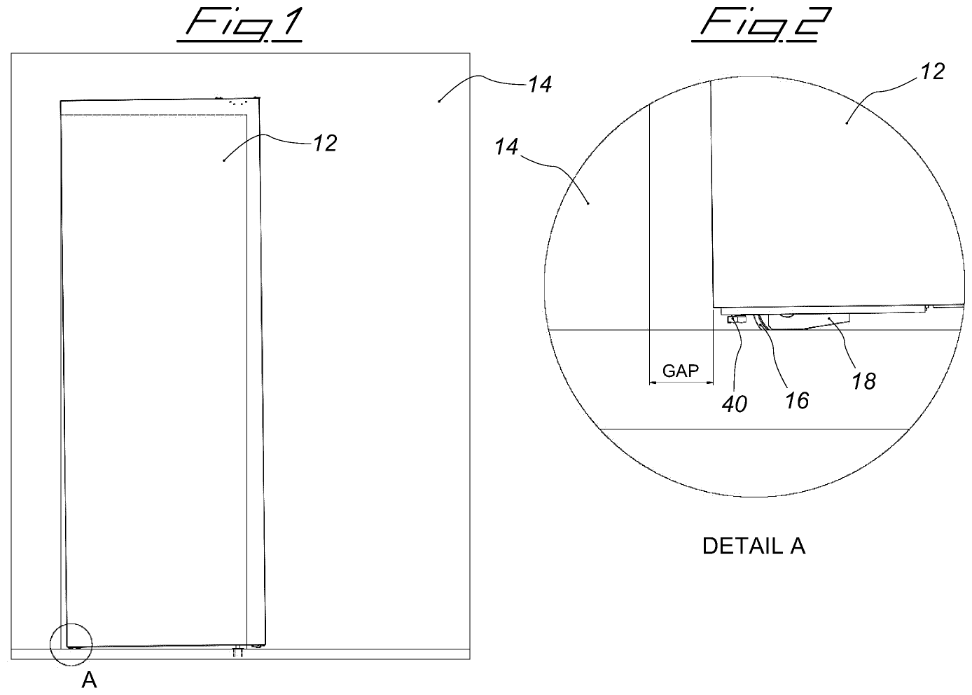

FIG. 1 schematically shows a sliding door that is not aligned vertically, in the center-bottom portion, with respect to the wall; FIG. 2 shows a partial enlargement of FIG. 1, as an example of the extent of the height difference of the sliding door;

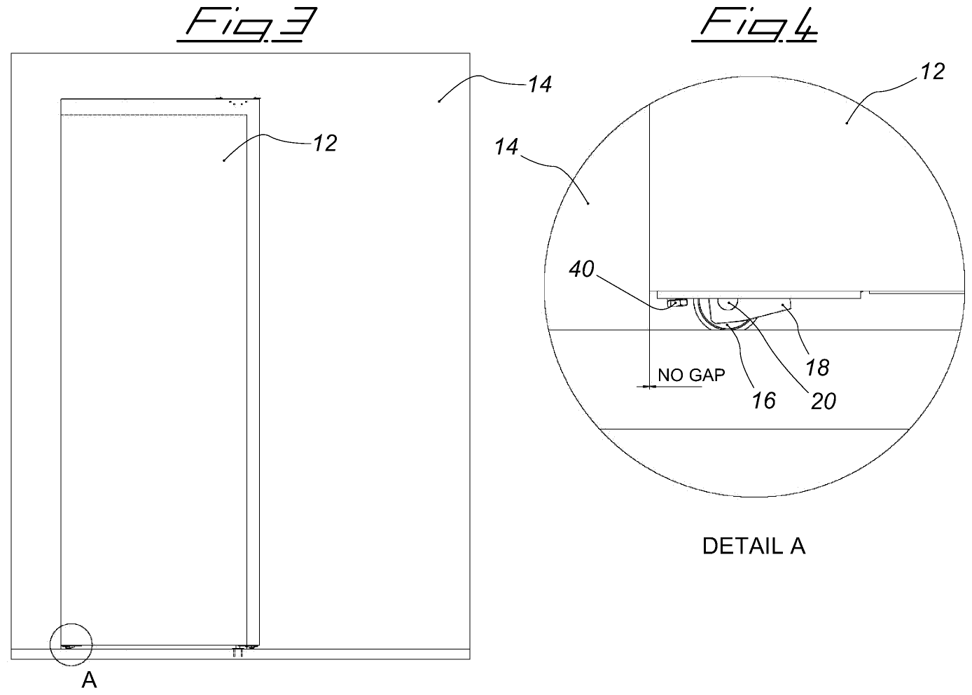

FIG. 3 schematically shows a vertically perfectly aligned sliding door;

FIG. 4 shows a partial enlargement of FIG. 3, to emphasize the total absence of height difference of the sliding door from the wall;

FIG. 5 schematically shows, in exploded view, the adjustable device of the invention in an upside-down position for more clarity;

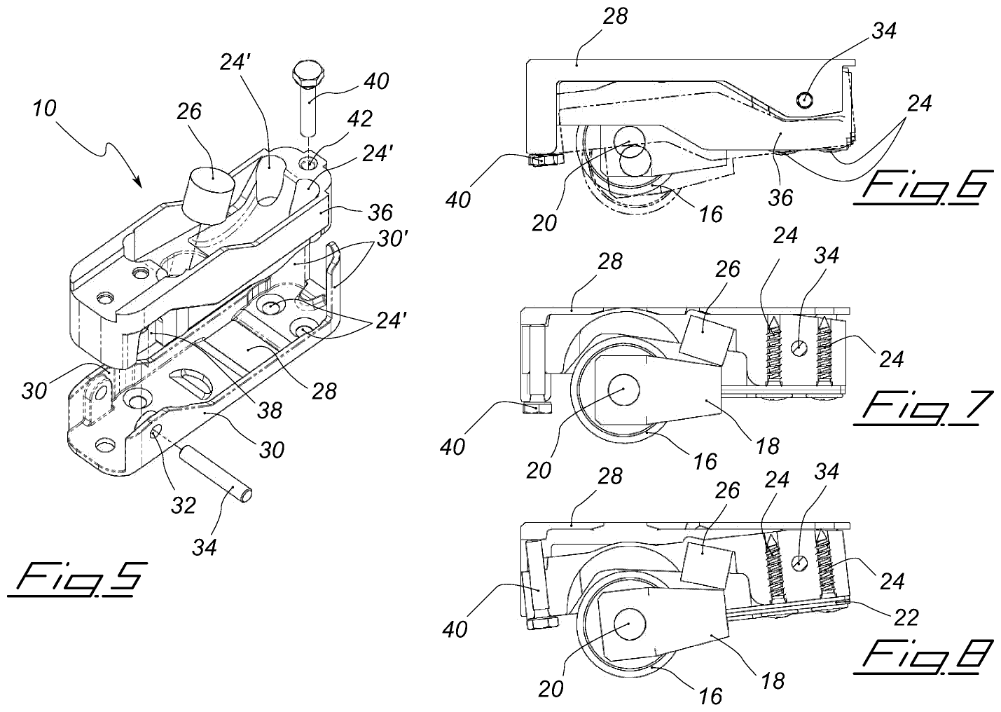

FIG. 6 schematically shows a side view of the adjustable device of the invention, to emphasize the possible exposure of the sliding wheel on the floor;

FIG. 7 schematically shows a partial section sideview of the same device in the neutral position, that is, without any adjustment having been made to it;

FIG. 8 schematically shows a partial section sideview of the same device, with the adjustment completely applied to.

With initial reference to FIGS. 1 and 2, the adjustable device of the invention is attached to and partially integrated into a seat formed along the bottom edge of a sliding door 12; in this description, reference will be made to a single adjustable device, understanding, however, that the sliding door includes, along its bottom edge, a pair of such devices, positioned at opposite ends of the door.

In particular, said devices are arranged adjacent to the longitudinal milling where the pin or appendage protruding from the floor is positioned, according to the solution described in EP 3,665,352. FIG. 1 shows that door 12 is not aligned vertically with the wall, indicated by 14; the enlarged view in FIG. 2 emphasizes the extent of the height difference that requires corrective action by means of the device of the invention, as further detailed below. FIG. 3, on the other hand, shows sliding door 10 perfectly aligned vertically with the wall, and the enlarged view in FIG. 4 emphasizes the absence of any height difference.

The adjustable device of the present invention is shown overall as 10 in FIG. 5, in which it is illustrated in exploded upside-down view to better identify its features and components. Said adjustable device comprises, similarly to the aforementioned solution disclosed in EP 3,665,352, a rubber wheel 16 connected to a frame 18 through a pin 20; from the frame 18, coupled to a known pad 26 made of elastomeric material, protrudes a pair of overlapping elastic sheets 22, fixed by screws 24 inserted in holes 24′ to the frame described below.

According to the invention, the adjustable device 10 comprises a frame consisting of two mutually articulated components made of plastic or metal. In particular, a first upper body constituting the fixing base 28, defining a substantially rectangular plane, is provided along the opposite major sides with integral flanks 30 folded at 90°; on each of said flanks, at one end of the fixing base 28, a through hole 32 is formed to accommodate a pin 34. At the opposite end the flanks 30 extend to form opposing arcuate walls 30′.

The adjustable device 10 of the invention comprises a secondary body or tilting support 36, likewise defining a substantially rectangular plane, intended to fit into the fixing base 28 between the flanks 30 and the arcuate walls 30′ which partially enclose it. Said tilting support 36 is provided, at one end, with a through hole 38 in which is inserted the pin 34 which provides the articulated connection with the fixing base 28.

According to a further advantageous embodiment of the invention, means are provided for determining such tilting, consisting of a screw 40 or the like; said screw is inserted into a threaded hole 42, made on the tilting support 36 at the opposite end from the hole 32 of the pin 34. The screw 40, e.g., with a hexagonal head, crosses the tilting support 36 and protrudes therefrom until it abuts the inner face of the fixing base 28, as shown in FIGS. 7 and 8; in FIG. 6, on the other hand, the more pronounced exposure of the wheel 16, resulting from the adjustment described below, is schematized.

The adjustable device 10 so assembled is inserted and stabilized in a known manner in the cavity formed at the base of the sliding door 12, from which it partly protrudes as shown in FIGS. 2 and 4; when a misalignment of the sliding door 12 is present, the screw 40 of either the devices 10 present at the opposite ends of said door is acted upon. The misalignment may be detected with respect to the edge of the passageway in the case of an aluminum framed sliding door, with respect to the abutting side wall in the case of abutting on a wall, or, again, with respect to the second door in the case of a double sliding door. Screwing of screw 40, which cannot slide longitudinally because its lower end is in contact with the fixing base 28, results in the progressive lowering of the tilting support 36 (FIG. 8), with the consequence that a sliding door 12 is brought into alignment, as shown in FIGS. 3 and 4. Adequate space for a wrench exists between the head of the screw 40 and the floor, which makes adjustment by the operator easy.

If the door instead of being made of wood is made of glass, it is fitted along the bottom edge with an aluminum profile, substantially in the shape of an “H,” suitable for housing the glass on one side and the known door sliders on the other.

As it can be noted from the above, the benefits that the invention achieves are obvious.

The adjustable device of the present invention allows the precise alignment of the sliding door 12 and double doors to be carried out quickly and smoothly, among other things compensating for any small depression in the floor and thus improving the sliding of the wheels 16.

Though the invention has been described with particular reference to one embodiment, given for illustrative and not limiting purposes, numerous modifications and variations will appear obvious to one skilled in the art in light of the above description. The present invention, therefore, is intended to cover all modifications and variations that fall within the protective scope of the following claims.

1) An adjustable device (10) for the movement on the floor of single or double sliding doors (12) to be aligned with a wall (14), inserted and stabilized in a cavity formed at the base of said doors from which it protrudes in part, comprising a rubber wheel (16) connected through a pin (20) to a frame (18), combined with an elastomeric pad (26) and provided with overlapping elastic sheets (22) fixed with screws (24) to a load-bearing frame, characterised in that said frame is formed by a fixing base (28) and by a tilting support (36) to which are attached said elastic sheets (22) and in which the means for the adjustment and alignment of said doors (12) are arranged, said means being screwable into a threaded hole (42) made on the same tilting support (36).

2) The adjustable device according to claim 1, characterised in that the fixing base (28) defines a substantially rectangular plane and is provided, along the opposite major sides, with integral flanks (30) folded at 90° on each of which, at one end of the same fixing base (28), a through hole (32) is formed to accommodate a pin (34) for connecting and articulating to the tilting support (36).

3) The adjustable device according to claim 2, characterised in that at the end opposite said hole (32), the flanks (30) extend to form opposite arcuate walls (30′).

4) The adjustable device according to claim 1, characterised in that said adjusting means determine the tilting of the support (36) and consist of a screw (40) or the like inserted in the threaded hole (42), made on said tilting support (36), at the opposite end with respect to the pin (34).

5) The adjustable device according to claim 4, characterised in that the screw (40) inserted in the threaded hole (42) crosses the tilting support (36) and protrudes therefrom until it abuts the inner face of the fixing base (28).

6) The adjustable device according to claim 5, characterised in that the tilting support (36) is at least in part delimited by the flanks (30) and by the arcuate walls (30′) of the fixing base (28) and is provided, at one end, with a through hole (38) in which said pin (34) is inserted which obtains the articulated connection with the same fixing base (28).

1) An adjustable device for the movement on the floor of single or double sliding doors to be aligned with a wall, inserted and stabilized in a cavity formed at the base of said doors from which it protrudes in part, comprising a rubber wheel connected through a pin to a frame combined with an elastomeric pad and provided with overlapping elastic sheets (22) fixed with screws (24) to a load-bearing frame, wherein said frame is formed by a fixing base and by a tilting support to which are attached said elastic sheets and in which the means for the adjustment and alignment of said doors are arranged, said means being screwable into a threaded hole (42) made on the same tilting support.

2) The adjustable device according to claim 1, wherein the fixing base defines a substantially rectangular plane and is provided, along the opposite major sides, with integral flanks folded at 90°on each of which, at one end of the same fixing base, a through hole is formed to accommodate a pin (34) for connecting and articulating to the tilting support.

3) The adjustable device according to claim 2, wherein at the end opposite said hole the flanks extend to form opposite arcuate walls (30′).

4) The adjustable device according to claim 1, wherein said adjusting means determine the tilting of the support and consist of a screw or the like inserted in the threaded hole, made on said tilting support, at the opposite end with respect to the pin.

5) The adjustable device according to claim 4, wherein the screw inserted in the threaded hole crosses the tilting support and protrudes therefrom until it abuts the inner face of the fixing base.

6) The adjustable device according to claim 5, wherein the tilting support is at least in part delimited by the flanks and by the arcuate walls (30′) of the fixing base and is provided, at one end, with a through hole (38) in which said pin is inserted which obtains the articulated connection with the same fixing base.
